(19) United States
(12) Patent Application Publication
(10) Pub. No.: US 2013/0327524 A1
(43) Pub. Date: Dec. 12, 2013

(54) METHOD FOR RECOVERING OIL FROM A RESERVOIR BY MEANS OF MICRO(NANO)-STRUCTURED FLUIDS WITH CONTROLLED RELEASE OF BARRIER SUBSTANCES

(71) Applicants: Marco Sangermano, Torino (IT); Francesca Verga, Torino (IT); Laura Montanaro, Torino (IT)

(72) Inventors: Marco Sangermano, Torino (IT); Francesca Verga, Torino (IT); Laura Montanaro, Torino (IT)

(73) Assignee: ENI S.p.A., Roma (IT)

(21) Appl. No.: 13/976,740

(22) PCT Filed: Dec. 27, 2011
(86) PCT No.: PCT/IB11/55973

§ 371 Date: Aug. 26, 2013

(30) Foreign Application Priority Data
Dec. 27, 2010 (IT) MI2010A 002412

(51) Int. Cl. C09K 8/58; E21B 43/16

(52) U.S. Cl. CPC C09K 8/58; E21B 43/16
USPC 166/270; 507/203; 507/225; 507/224; 507/268; 507/266; 507/244; 507/261; 507/231; 507/214; 507/260; 507/212

(57) ABSTRACT

The present invention relates to a method for oil recovery from a reservoir which comprises the following phases: a) injecting a volume of a micro (nano)-structured fluid with released control of barrier substances into at least a portion of an underground reservoir containing oil, said micro (nano)-structured fluid comprising an aqueous dispersion of microcapsules composed of a core comprising a modifying substance of the absolute permeability of the rock formation which houses said reservoir, a protective shell insoluble in water which coats said core; b) clogging the porous intergranular spaces of said rock formation with said modifying substance with a reduction or inhibition of the absolute permeability of said rock formation, c) recovering said oil from the remaining portion of said reservoir by the further injection of a displacing fluid, preferably water. The present invention also relates to the above microcapsules and an aqueous dispersion comprising the above microcapsules for use in the above method.

The present invention relates to a method for the recovery of oil from a reservoir by means of micro(nano)-structured fluids with controlled release of barrier substances.

The present invention also relates to the above micro(nano)-structured fluid with controlled release of barrier substances and a microcapsule containing the above barrier substances.

In the oil industry, the production of hydrocarbons (oil or natural gas) which exploits the natural energy, i.e. pressure, of a reservoir is called primary production. During primary production, the hydrocarbons flow towards the production wells thanks to natural driving mechanisms, generated by the progressive decrease in natural pressure of the reservoir, such as:

(i) the natural expansion of reservoir fluids and rock compaction (natural depletion drive),

(ii) the development of gases dissolved in the oil (dissolved gas drive) and/or

(iii) the flow of water from an aquifer (water drive).

The prevailing driving mechanism depends on the characteristics of the fluids and reservoir. Water drive is the mechanism which allows the greatest quantity of oil to be recovered.

In a reservoir with a driving mechanism of the water drive type (hereunder also indicated as water drive reservoir), the oil, which occupies part of the porous and permeable rock (reservoir), is in contact with the aquifer. The aquifer, consisting of the porous and permeable water-saturated rock formation, can be located beneath the layer (or at least a part of it) comprising the oil or delimit the mineralization laterally.

As the production of hydrocarbons proceeds, the decrease in pressure inside the reservoir is also transmitted to the aquifer which delimits the oil, with a consequent expansion of the water. The expansion creates a water flow, inside the reservoir rock, which tends to re-establish the original pressure of the formation and displace the oil towards the production wells.

In a water drive reservoir, the extension of the aquifer is therefore the main factor which determines the quantity of energy available for compensating the decrease in pressure induced by the production and for oil displacement.

When the aquifer is sufficiently extended, through a suitable regulation of the extraction flow from the production well, the water driving mechanism can be exploited for recovering a significant part of the oil from the reservoir. The quantity of oil that can be recovered, however, also depends on other factors, such as for example the structure and petrophysical characteristics of the reservoir rock, the properties of the oil (in particular, the viscosity) and the position of the production wells. Among these factors, it is particularly important the degree of heterogeneity of the reservoir rock, which, if high, can limit the efficacy of the oil displacement by water to small portions of the reservoir.

When aquifers are not present in the reservoir, or when there are aquifers with such a limited extension that the volumes of oil produced cannot be replaced, or can only be partially replaced, the oil production can be increased by injection, from the outside, of fluids immiscible with the hydrocarbon to be extracted (for example, water, or gas). The injections of immiscible fluids are aimed, on the one hand, at keeping the reservoir pressure constant at values slightly higher or equal to the saturation pressure and, on the other, at driving (“displacing”) the hydrocarbons towards the production wells.

The recovery of oil by injection into the reservoir of immiscible fluids is commonly called Improved Oil Recovery (IOR).

In improved oil recovery, the oil initially present in the pores of the reservoir rock is displaced by the immiscible fluid (also called displacing fluid) which replaces the oil. For this purpose, wells are drilled in the oil field, for the injection of the displacing fluid, which are positioned so as to create an advancing front as uniform as possible in the subsoil.

The displacing fluid most frequently used is water. As an alternative to water, natural gas associated with the production of oil can be used, for example. The improved recovery by injections of gas, however, is less effective than that of recovery with water.

The displacement technique by injections of water (water flooding) has long been the simplest and most economical technique used for sustaining the production from an oil field and increasing the overall oil recovery factor.

The quantity of oil that can be displaced towards production wells by water injection depends, among other factors, on the degree of heterogeneity of the reservoir rock and properties of the oil (above all its viscosity). In particular, fractures, channels or high-permeability levels (the latter also called thief zones) form preferential flow paths. The natural tendency of fluids to flow through the most permeable portions of reservoir rock implies that, in time, the water injected into the subsoil continues to flow along these fractures, channels or high-permeability levels directly reaching the production wells, without infiltrating or infiltrating only to a limited extent in the zones of the reservoir rock where oil is still present, thus producing no displacement effect.

In these cases, the production of water can increase until it prevails over that of mineral oil, thus making the production of the latter less convenient or even not convenient at all from an economical point of view.

Furthermore, the co-production of water implies the use of specific treatment facilities for safely disposing the produced water, or the use of systems for its re-injection into the subsoil. These measures require high consumptions of energy and materials (for example, chemical additives) and increase the overall extraction cost of hydrocarbons.

In the state of the art, the problem of the undesired production of water and inadequate efficiency of the improved recovery of hydrocarbons by water displacement, is faced by resorting to the injection into the subsoil of aqueous solutions containing chemicals capable of modifying the permeability characteristics of the reservoir rock. The chemicals used for this purpose are generally polymers, gels or foams. These chemicals are known as relative permeability modifiers.

An example of the use of this technique is described in U.S. Pat. No. 3,965,986. This document describes a method for improving oil recovery based on a reduction in the water permeability in selected portions of a reservoir, so as to force a subsequent injection of water to penetrate a zone of the reservoir not yet reached by the water. The reduction in the permeability is obtained through a first injection of an aqueous dispersion of colloidal silica, followed by a second injection of water containing a surfactant, with the formation of a gel which reduces the permeability of the porous matrix. The displacement fluid subsequently injected is therefore forced to flow into the zones of the reservoir rock not blocked by the polymeric gel.

State-of-the-art methods based on the injection of relative permeability modifying compounds or on the formation in situ of such compounds, have various disadvantages.

Firstly, the known methods produce effects on the mobility of the water in the reservoir only in the immediate proximity of the injection well (within a radius in the order of a few meters of distance from the well), but do not influence the overall efficacy of the water displacement at the reservoir scale. The benefits in terms of hydrocarbon recovery increase are consequently extremely limited.

Secondly, the method described in U.S. Pat. No. 3,965,986, which envisages the injection of the colloidal silica and the surfactant (reagents) in subsequent times, does not guarantee the complete transformation of the reagents in the final permeability modifying compound. With this injection procedure, in fact, it can be reasonably predicted that the reagents will not completely and uniformly mix with each other.

In consideration of the state of the art described above and the increasingly limited availability of new reservoirs, the necessity is strongly felt in the oil extraction industry for finding more effective recovery methods of hydrocarbons which allow an increase in the productivity of an oil field. In particular, the necessity is felt of finding recovery methods which can be applied to mature reservoirs (i.e. in an advanced production phase), which allow higher recovery factors of hydrocarbons to be reached, in relation to those that can be obtained with the state-of-the-art methods.

An objective of the present invention is to overcome the drawbacks revealed by the state of the art.

Therefore, an object of the present invention is a method for the recovery of oil from a reservoir comprising the following phases:

a) injecting a volume of a micro(nano)structured fluid with controlled release of barrier substances into at least a portion of an underground reservoir containing oil, said micro(nano)structured fluid comprising an aqueous dispersion of microcapsules composed of
a core comprising a modifying substance of the absolute permeability of the rock formation which contains said reservoir,
a protective shell insoluble in water which coats said core;

b) clogging the porous intergranular spaces of said rock formation with said modifying substance with a reduction or inhibition of the absolute permeability of said rock formation,

c) recovering said oil from the remaining portion of said reservoir by further injection of a displacing fluid, preferably water.

According to a preferred aspect, the method of the present invention can be applied particularly to an oil reservoir where the oil originally contained in a high-permeability portion has already been displaced and produced by water injection.

A second object of the present invention is a microcapsule consisting of
a core comprising a modifying substance of the absolute permeability of the rock formation of an oil reservoir,
a protective shell insoluble in water which coats said core.

Further objects of the present invention relate to a micro(nano)structured fluid comprising an aqueous dispersion of the abovementioned microcapsules and the use thereof in the abovementioned method for recovering oil from a reservoir.

In the following description, reference will be made to the application of the method of the present invention for the recovery of oil from an underground reservoir.

For a better understanding of the characteristics of the present invention, reference will be made in the description to the following figures:

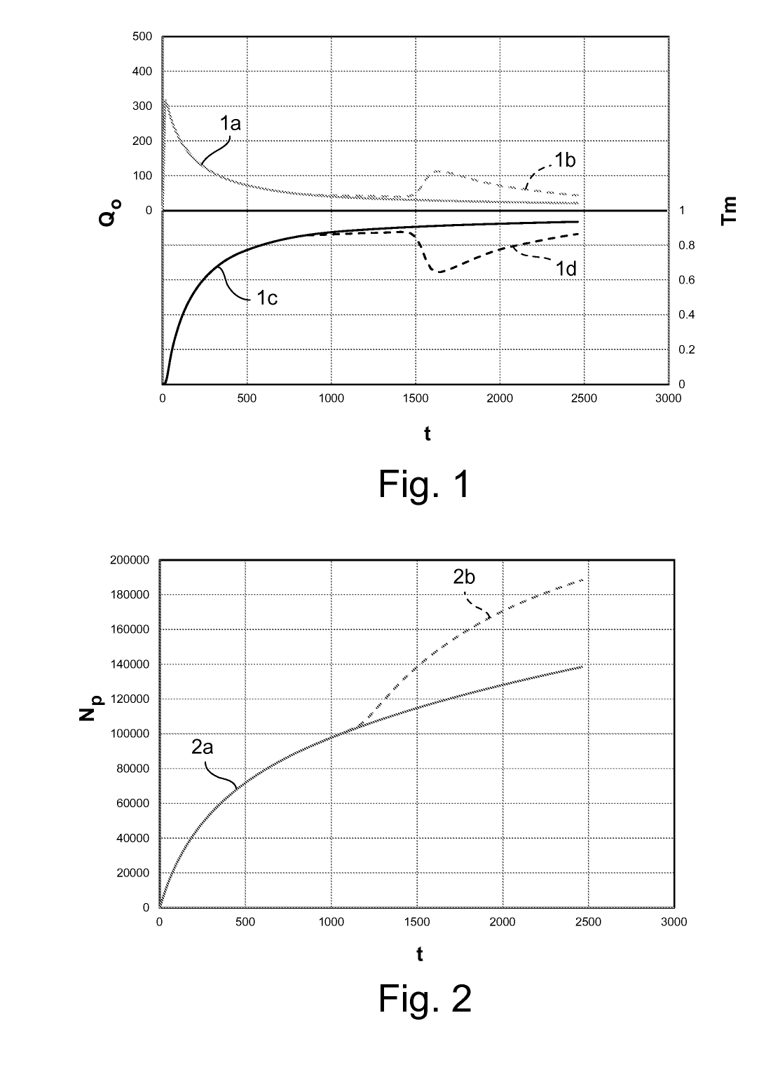

FIG. 1, which indicates the results of a mathematical simulation of the flow-rate curves of oil production (Qₒ) (in m³_{ST}/day), and of the value of the fraction (Tₘ) of water to the total liquid production versus time (t), in the absence and in the presence (dashed line) of injection of barrier substances;

FIG. 2, which indicates the results of a mathematical simulation of the cumulative oil production curves (Np) versus time (t), in the absence and in the presence of injection of barrier substances;

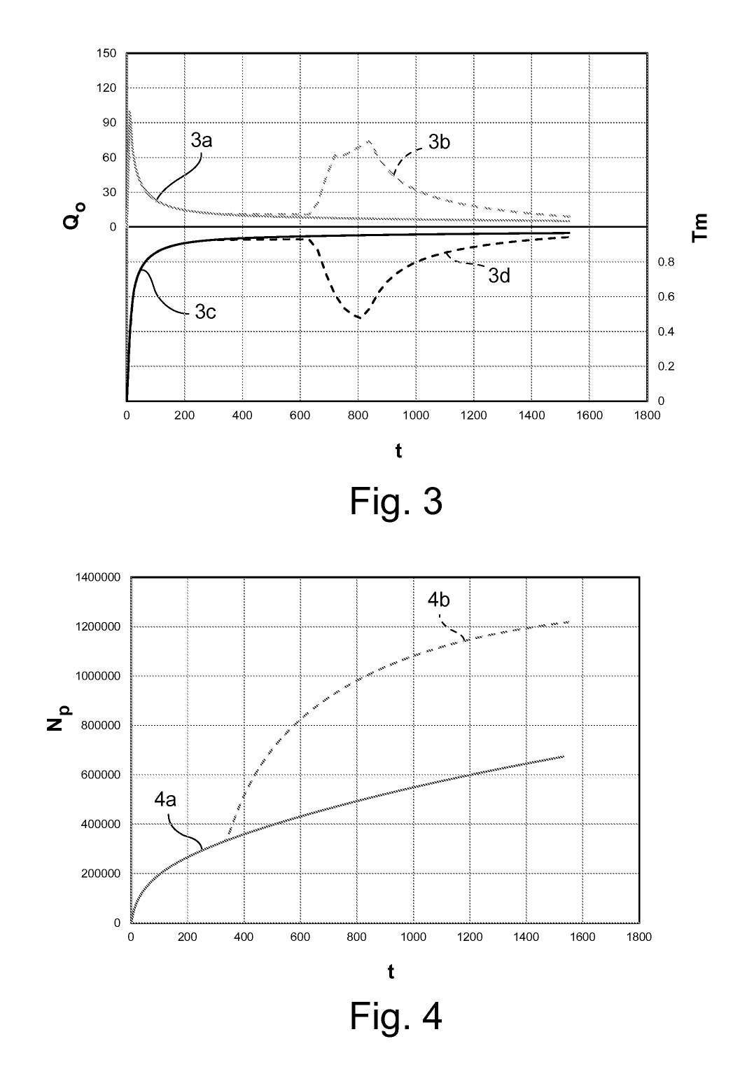

FIG. 3, which indicates the results of a mathematical simulation, for an alternative scenario to that of FIG. 1, of the flow-rate curves of oil (Qₒ) (m³_{ST}/day) and of the value of the fraction (Tₘ) of water to the total liquid production versus time (t), in the absence and in the presence of injection of barrier substances;

FIG. 4, which indicates the results of a mathematical simulation, for an alternative scenario to that of FIG. 2, of the cumulative oil production curves (Np) versus time (t), in the absence and in the presence of the injection of barrier substances.

The method, object of the present invention, allows the increase of the recovery efficiency from an oil-bearing formation in the presence of strong geological heterogeneities, for which the simple injection of water would not be suitable or in any case would only allow the oil to be displaced from some portions of the reservoir.

The method of the present invention is based on the reduction in permeability of a portion of a reservoir characterized by a high permeability to fluids. The reduction, partial or complete, of the fluid permeability of a first high-permeability portion of the reservoir enables the subsequent injection of a displacement fluid into a second portion with a lower permeability of the same reservoir. The displacement fluid can therefore act on the oil fraction present in the above second portion of reservoir, displacing it towards the production wells.

In accordance with the present invention, the reduction in permeability is obtained by the injection into the subsoil (phase a) of microcapsules containing a substance which gives rise in situ to chemical or physical phenomena suitable for modifying the absolute permeability of the rock formation which contains the reservoir. The microcapsules are injected into the subsoil in the form of an aqueous dispersion.

The injection wells used for improved oil recovery by displacement with immiscible fluids (preferably water) can be used for effecting the injections: they can be either injection wells drilled on purpose, or production wells converted into injection wells.

Once the portion of reservoir whose permeability is to be modified has been reached, the microcapsules release their core content which, as a result of chemical or physical transformations, forms substances in situ, capable of clogging the intergranular porous spaces of the reservoir rock (phase b). In the following description the permeability modifying substances which block the flow of fluids through the interconnected pores of the rock formation are also indicated with the expression “barrier substances”.

The permeability modifying substances clog the pores of the rock formation into which they are injected, thus acting as a barrier to the passage of fluids. As the displacement fluid subsequently injected (phase c) cannot pass through the portion of rock clogged by the barrier substance, it is consequently forced to flow through other reservoir zones with a lower permeability, thus pushing the oil present in these zones towards the production wells.

With the method of the present invention, the area of the reservoir on which it is possible to intervene for modifying the permeability of the underground rock formation can have relevant dimensions, up to affecting a zone which extends for various hundreds of meters, in the portion of reservoir between the injection well and the production well(s). This allows the displacing fluid to also be directed into zones with a lower permeability, thus increasing oil recovery with respect to what can be obtained with the state-of-the-art methods.

Examples of barrier substances known in the state of the art are inorganic gels and organic gels (also called polymer gels). Among inorganic gels, gels obtained by the gelification of metal-alkoxide compounds, in particular alkoxy-silanes (Si-alkoxides) are particularly effective.

Among organic gels, polyacrylamide gels, obtained by the copolymerization of acrylamide and N,N′-methylene-bis-acrylamide, and starch-based gels, obtained by the gelification of starch with water, are particularly preferred.

As already mentioned, the micro(nano)structured fluid with controlled release of barrier substances, object of the present invention, consists of an aqueous dispersion of microcapsules containing an absolute permeability modifying substance of the reservoir rock

Once they have been injected into the subsoil, the microcapsules contained in the fluid migrate to the desired position, where they release the contents of the core.

In a preferred embodiment of the method of the present invention, the micro(nano)structured fluid necessary for modifying the absolute permeability of the reservoir is injected into the subsoil discontinuously, i.e. it is injected in consecutive volumes, alternating with the injection of volumes of water.

In this embodiment, the injection of a first volume of micro(nano)structured fluid is followed, in the same portion of reservoir, by an injection of a volume of water which pushes the volume of fluid towards a zone of the reservoir whose absolute permeability is to be modified. The first volume of fluid injected into the subsoil is typically made to migrate toward proximity of the production well by injection of water.

Once it has reached its destination, the barrier substance is released from the microcapsules, according to various possible physical or chemical reaction mechanisms, and creates in situ compounds capable of reducing the permeability of the rock portion that it has reached.

After modifying the absolute permeability of the rock formation as described above, a second volume of micro(nano)structured fluid is injected into the reservoir and then pushed, by means of a subsequent injection of water, until it reaches the proximity of the first portion of reservoir whose permeability has been modified by the action of the first volume of injected micro(nano)structured fluid. Again, the barrier substance contained in microcapsules of the second volume of fluid is released, creating in situ compounds capable of reducing the permeability of the portion of rock formation it has reached.

The alternating injection of micro(nano)structured fluid and water is repeated, once or several times, until, thanks to the clogging of the intergranular spaces, the permeability to fluids in the portion of reservoir of interest (which is originally high and in any case higher than the permeability in other portions or levels of the mineralized formation) has been completely inhibited or in any case sufficiently reduced.

At this point, it is possible to proceed with phase c) of the method, which provides the recovery of the oil from the remaining portion of the reservoir by the injection of a displacement fluid, preferably water.

The microcapsules consist of a core, containing the barrier substance, and a shell which covers the whole surface of the core.

The material which forms the shell is insoluble in water.

The microcapsules substantially have a spherical form and a diameter within the range of 0.01-30 μm.

The mode and release time of the contents of the core can be controlled by suitably selecting the material of which the shell of the microcapsules is composed and the thickness of the shell in relation to the characteristics of the reservoir and distance between the injection well and production well. The release time also depends on the temperature at which the microcapsules are exposed.

In a first preferred embodiment of the present invention, the contents of the nucleus are released in a controlled form by the dissolution of the protective shell of the microcapsules by contact with the oil present in the reservoir. The dissolution occurs by contact between the shell of the microcapsules and the oil present in the reservoir at least in a quantity equal to the residual oil saturation. In this embodiment, the shell is produced with a material soluble in oil.

In a second preferred embodiment, the contents of the nucleus are released in a controlled form by the thermal decomposition of the protective shell of the microcapsules, once these have penetrated the high-permeability regions of the reservoir and have reached warmer zones, i.e. zones with a temperature higher than the injection temperature of the micro(nano)structured fluid. In the warmer zones, the temperature must be equal to or higher than the decomposition temperature of the material of the shell.

In a third preferred embodiment, the contents of the nucleus are released in a controlled form in the high-permeability zone of the reservoir by diffusion through the protective shell. For this purpose, the shell is produced with a material permeable to the barrier substance contained in the core; the barrier substance is then distributed at a controlled rate through the shell.

By suitably varying the chemical composition of the shell, it is therefore possible to accurately control both the release point of the precursor of the barrier substances inside the reservoir and also the formation rate of the barrier itself. The formation rate of the barrier also depends on the type of chemical or physical phenomenon involved (polymerization, swelling).

In order to enable the microcapsules to reach unaltered the zone of the reservoir whose absolute permeability is to be modified, the material of which the shell of the microcapsules is composed must be insoluble in water. Insoluble material means a material having a sufficiently low dissolution rate in water as to guarantee that the microcapsules can be injected into the subsoil in the form of an aqueous dispersion.

The material composing the shell can be selected from a wide range of polymeric materials known in the state of the art. Examples of polymeric materials are: polyethyleneglycol, polyacrylate, polymethacrylate, polystyrene, cellulose, polylactate, poly(lactic-co-glycol) copolymer.

The use of mono- and multi-functional acrylic resins polymerizable by means of UV radiations is particularly preferred.

Monofunctional acrylic resins are resins based on mono-unsaturated acrylic monomers, such as, for example, esters and amides of acrylic and methacrylic acid, particularly methylmethacrylate. Multifunctional acrylic resins according to the present invention are cross-linkable resins comprising multifunctional acrylic monomers such as polyunsaturated acrylic compounds such as ethyleneglycole dimethacrylate, or vinyl methacrylate. According to what is generally known in the art, multifunctional acrylic resins comprise a mixture of both monofunctional and multifunctional acrylic monomers.

The use of monofunctional acrylic resins allows thermoplastic coating shells, insoluble in water and soluble in the oil phase, to be obtained.

By using multifunctional acrylic resins, on the other hand, rigid shells are obtained, which are insoluble in both water and oil, due to the high crosslinking degree which can be obtained with the polymerization of these resins. In these microcapsules, the contents of the core are released by diffusion through the polymeric material of the shell. The diffusion rate can be controlled by varying the thickness of the shell. The diffusion rate also depends on the diffusion coefficient of core material in the shell material.

The choice of the absolute permeability modifying substance varies in relation to the desired type of barrier to fluid flow.

In order to modify the absolute permeability of a reservoir by the formation in situ of an inorganic gel, for example, the core can consist of a compound belonging to the group of organometallic compounds, in particular metal-alkoxides, wherein the metal is selected, for example from Si, Al, Ti and Zr. The metal-alkoxide compound is preferably an alkoxy-silane, more preferably a compound selected from the group consisting of tetramethylorthosilane (TMOS), tetraethylorthosilane (TEOS), trimethylmethoxysilane (TMMS), methyltrimethoxysilane (MTMS) and methyltriethoxysilane (MTES).

A particularly preferred Si-alkoxide compound is TMOS, which is insoluble in water and slightly soluble in oil.

The above-mentioned metal-alkoxide compounds, when in contact with water, are transformed into gels according to the reaction mechanism known as the “sol-gel” process. The inorganic gel formed modifies the permeability of the reservoir.

The properties of inorganic gels (for example, the rigidity) and rate of their formation process (gelification) depend on various parameters such as the nature of the barrier substance, temperature of the gelification process, salinity of the water, pH value.

In order to control and/or favour the gelation process, the core can also contain catalysts or other additives of the type generally used in gelifying systems known in the art, such as surfactants, stabilizers, antifoaming agents and pH buffers.

In order to modify the absolute permeability of the rock formation by means of a polymeric gel of the organic type, a monomer and/or pre-polymer must react with a crosslinking agent in the desired point of the rock formation, in order to form the polymeric gel.

For this purpose, the method, object of the present invention, envisages the injection of an aqueous dispersion comprising microcapsules having a core consisting of one or more monomers and/or pre-polymers (monomer-microcapsules) and microcapsules having a core consisting of a crosslinking agent (crosslinking-microcapsules).

The monomer-microcapsules and crosslinking-microcapsules can be injected into the subsoil either consecutively or simultaneously in a single aqueous dispersion, the latter being preferred.

Monomers and/or pre-polymers suitable for the purposes of the present invention are, for example, acrylamide, N,N′-methylene-bis-acrylamide and partially hydrolyzed polyacrylamide.

The crosslinking agents (also called polymerization initiators) generally consist of metallic compounds, in particular compounds of Cr or Al, organic compounds, for example aldehydes (glutaraldehyde, formaldehyde), phenol, o-aminobenzoic acid, m-aminophenol, phenylacetate and furfuryl alcohol.

Once the monomer-microcapsules and crosslinking-microcapsules have reached the desired point of the rock formation, they each release their core constituent initiating the polymerization. The formed polymeric gel clogs the porous intergranular spaces of the rock formation, blocking its permeability to fluids.

In a preferred embodiment of the present invention, the formation in situ of the polymeric gel is obtained by injecting into the subsoil:
monomer-microcapsules having a core of acrylamide monomer,
monomer-microcapsules having a core of N,N′-methylene-bis-acrylamide,
crosslinking-microcapsules having a core of ammonium persulfate and tetramethylethylenediamine (TEMED). The ammonium persulfate and TEMED act as polymerization initiators.

The above microcapsules have a coating shell soluble in oil, preferably a coating shell made of polyacrylate.

Once the core of each of the above types of microcapsule is released, the polymerization reaction is initiated in the rock formation, leading to the formation of a polyacrylamide gel.

In a further preferred embodiment, the core consists of starch. The term “starch” means a polysaccharide consisting of a glucose unit bound to another unit by means of α(1-4)-glycoside bonds, characteristic of amylose, and α(1-6)-glycoside bonds, characteristic of amylopectin.

Starch is insoluble in water at room temperature, whereas it begins to gelify within a temperature range of 60-80° C. As a result of contact with the aqueous phase, starch loses its original crystalline structure and the water molecules are bound by hydrogen bonds to the exposed hydroxyl groups of the amylase and amylopectin units, causing a swelling of the granules. As starch is a polymer of a natural origin, its use in the method of the present invention as permeability modifying substance has the particular advantage of not introducing substances potentially dangerous for the environment into the subsoil.

The microcapsules having a core comprising starch, are preferably covered by a protective shell made of a material soluble in oil, more preferably a shell made of polyacrylate.

In a further preferred embodiment, the microcapsules have a core of TMOS covered with an oil-soluble polymeric shell, preferably a shell made of polyacrylate.

The microcapsules are prepared according to encapsulation processes known in the state of the art.

The encapsulation technique is used for the preparation of micro- or nano-capsules for the controlled release of active principles for applications in the pharmaceutical, cosmetic, agrochemical field or in the industry of coating compositions (paints, inks, etc.).

For the preparation of the microcapsules of the present invention, the encapsulation of the barrier substances can include a preparation phase of oil-in-water micro- or nano-emulsions or water-in-oil-in-water micro- or nano-emulsions containing the barrier substances and/or compounds necessary for the formation of the shell of the microcapsules, followed by a separation phase of the microcapsules from the respective emulsions.

In the case of precursors insoluble in water (for example starch) the microcapsules can be obtained by emulsion polymerization starting from a dispersion of starch in the monomer (organic phase) of the material which will form the shell. This dispersion is added to an aqueous phase which can contain emulsion stabilizers, for example amphiphilic surfactants, such as polyhydroxybutyrate, polyoxyethylene dodecyl ether, sodium dodecylsulfate and poloxamers, such as poly(ethylene oxide-b-propylene oxide) copolymer (known with the trade-name of Pluronic®).

The organic phase can consist of the monomer alone or a solution of the monomer in suitable organic solvents. The mixing is effected by adding the organic phase to the aqueous phase, kept under constant stirring. An oil-in-water emulsion is obtained from the mixing, consisting of tiny drops of organic phase dispersed in the aqueous phase. The concentration and dimensions of the drops can be controlled by varying the composition and concentration of the components of the emulsion.

After emulsion polymerization, the drops are then separated from the aqueous phase in the form of microcapsules, by centrifugation and then washed with water and subjected to drying, for example by means of freeze-drying treatment. The separation of the microcapsules from the emulsion can also be done by sedimentation. At the end of the drying, the microcapsules can be used for the preparation of the aqueous dispersion to be injected into the subsoil.

In the case of water-soluble precursors, for example acrylamide and N,N′-methylene-bis-acrylamide, the encapsulation can be obtained by preparing a water-in-oil-in-water emulsion of each of the above compounds.

The water-in-oil-in-water emulsion can be prepared by dripping an aqueous solution of the precursor into a continuous organic phase, kept under stirring, containing emulsion-stabilizer compounds (for example, of the same type as those described for the case of the encapsulation of water-insoluble precursors).

The obtained water-in-oil emulsion is then mixed in turn with a continuous aqueous phase, kept under stirring, containing the compound which forms the shell of the microcapsules (for example, butylacrylate or propylacrylate), thus obtaining the water-in-oil-in-water emulsion. After emulsion polymerization, the microcapsules are separated by centrifugation, washed with water and subjected to drying, for example by means of freeze-drying.

The concentration in the aqueous phase or organic phase of the barrier substance forming the core of the microcapsules typically varies within the range of 0.1-50% by weight with respect to the overall weight of the phase.

The concentration in the aqueous phase or organic phase of the substance used for forming the shell of the microcapsules varies within the range of 0.01-25% with respect to the overall weight of the phase.

The concentration of the emulsion stabilizers in the aqueous or organic phase varies within the range of 0.01-1% with respect to the overall weight of the phase.

The microcapsules containing a rigid shell of acrylic resin can be prepared, as previously described, by means of the emulsion polymerization technique, using, in this case, an at least bifunctional acrylic resin.

The barrier substance (for example TMOS) is mixed with a solution in an organic solvent containing an acrylic resin (for example, an epoxy-acrylic resin) and a suitable crosslinking agent (for example, a photo-initiator). Preferred crosslinking agents are pentaerythritol triacrylate (PETA), bis-phenol-A epoxy-diacrylate and tri-propyleneglycol triacrylate.

The solution can also contain an amphiphilic surfactant, for example 3-methacryloyloxy-2-hydroxy-propane-sulfonate.

The emulsion is then exposed to UV radiation. As a result of the UV radiation, the acrylic resin present around the drops of barrier substance, polymerizes, forming a rigid coating shell of acrylic polymer.

The encapsulation techniques described above can be applied with equipment known in the state of the art.

The chemical substances which can be used for the preparation of the microcapsules are known in the state of the art and are available on the market.

For the purposes of the present invention, the microcapsules are used for preparing a micro(nano) structured fluid to be injected into the subsoil, with controlled release of barrier substances.

The fluid is prepared in the form of an aqueous dispersion of the microcapsules.

The fluid is prepared in concentrated form and diluted with water until an adequate viscosity is obtained for its injection into the aquifer. The viscosity of the fluid is generally comparable to that of water and varies within the range of 0.4-2 cP.

The amount of barrier substance and therefore of micro(nano)structured fluid to be injected, varies in relation not only to the desired characteristics for the permeability barrier, but also to other characteristics of the reservoir and aquifer (for example, geometry of the reservoir, characteristics of the well through which the injection is effected, permeability of the rock formation, temperature, viscosity of the oil, salinity of the water, etc.).

The micro(nano)structured fluid is injected into the subsoil with the equipment and according to the techniques known in the state of the art in the field of the oil extraction industry.

The displacement fluid injected in phase c) of the process is preferably water.

The method, object of the present invention, can be applied either from the initial phases of the reservoir exploitation, in particular if the injection of water is envisaged from the very beginning of oil production, or when the exploitation has already started, as in both cases it is possible to block the permeability to fluids in the zones from which the oil has already been displaced and produced.

The method of the present invention is preferably applied after the oil present in the zones of the reservoir with the highest permeability has already been produced.

The injections of the micro(nano)structured fluid in the high-permeability zones can be repeated until the desired reduction in permeability has been obtained for the specific portion of reservoir in which the fluid is injected.

The micro(nano)structured fluid is preferably injected through an injection well located at a distance varying from 100 m to 1,000 m from the extraction well.

The injection strategy must be specifically verified in relation to the geometrical characteristics of the well-reservoir system, the petrophysical properties of the reservoir rock and the characteristics of the oil.

According to a preferred aspect of the method of the present invention, the injection of a certain quantity of micro(nano)structured fluid is followed by the injection of water, with the aim of both promoting the displacement of the fluid in the zones (with the highest permeability) where the formation of the barrier is desired, and also obtaining the subsequent displacement of the oil from the rock formation containing it, towards the production well. The succession of injection steps of the micro(nano)structured fluid and water can be repeated various times, until the desired exploitation of the reservoir has been reached.

The modification of the permeability obtained by the injection of the microcapsules, object of the present invention, into the subsoil, not only allows the production of oil from portions of reservoir with a lower permeability, but also reduces the co-production of water, thus further increasing the overall efficiency of oil recovery from the field.

The following embodiment examples are provided for purely illustrative purposes of the present invention and should not be considered as limiting the protection scope defined by the enclosed claims.

### EXAMPLE 1

Microcapsules having a core containing substances capable of forming, in situ, a barrier of polyacrylamide gel and a polyacrylate shell were prepared as follows.

Three separate solutions in chloroform were prepared, respectively containing 20% by weight of acryl-amide, 15% by weight of N,N′-methylene-bis-acrylamide and 2% by weight of ammonium persulfate and TEMED, as radical initiator (the latter percentage refers to the sum of ammonium persulfate and TEMED). Each organic solution was then dripped into an aqueous solution, kept under constant stirring, containing 10% by weight of butylacrylate, 0.5% by weight of sodium dodecylsulfate as amphiphilic surfactant and 1% by weight of radical photo-initiator of the benzoinic type.

Each of the obtained emulsions was subjected to emulsion polymerization by irradiation with a UV lamp in an inert atmosphere.

The microcapsules obtained at the end of the polymerization were centrifuged to separate them from the liquid. After being washed with water, the microcapsules were then subjected to drying by means of freeze-drying at a pressure lower than 0.1 mbar and a temperature close to −50° C.

### EXAMPLE 2

Microcapsules having a starch core and a polyacrylate shell were prepared following the procedure described in Example 1.

The organic phase consists of a suspension at 30% by weight of starch in an organic solution of ethanol containing 15% by weight of butylacrylate, 0.5% by weight of sodium dodecylsulfate as amphiphilic surfactant and 1% by weight of radical photo-initiator of the benzoinic type.

The organic phase was dripped, under stirring, into an aqueous solution containing 0.5% by weight of sodium dodecylsulfate as amphiphilic surfactant (aqueous phase).

The emulsion was then irradiated with an ultraviolet source in an inert atmosphere until the complete polymerization of the shell of the microcapsules.

The microcapsules obtained at the end of the polymerization were centrifuged to separate them from the liquid. After being washed with water, the microcapsules were then dried in an oven at 40° C.

### EXAMPLE 3

Microcapsules having a core containing tetramethylorthosilane (TMOS) and a shell of acrylic polymer were prepared with the following emulsion polymerization procedure.

An emulsion in dodecane was prepared, containing:

15% by weight of TMOS;

15% by weight of epoxy-acrylic resin;

0.5% by weight of 3-methacryloyloxy-2-hydroxy-propane-sulfonate;

1% by weight of radical photo-initiator of the benzoic type (percentages referring to the overall weight of the emulsion).

The emulsion was then subjected to UV radiation until the complete polymerization of the shell of the microcapsules. The microcapsules were separated by centrifugation, washed and subjected to drying by means of freeze-drying at a pressure lower than 0.1 mbar and a temperature close to −50° C.

### EXAMPLE 4

The in situ release of barrier substances capable of modifying the reservoir permeability and the effectiveness of subsequent water injection(water flooding) into the subsoil of a hypothetical oil reservoir, characterized by a high degree of heterogeneity, was simulated by means of a mathematical model.

The simulation software called “ECLIPSE Black Oil” (produced by Schlumberger) estimated the variation in the recovery factor (RF) in two different scenarios: a reservoir having high-permeability layers and a reservoir having high-permeability channels.

The recovery factor (RF) is the ratio between the quantity of oil that is estimated to be produced and the quantity of oil originally present in the reservoir.

Scenario 1—Reservoir with High-Permeability Layers

A reservoir located at a depth of 2,000 m, with an initial pressure of 200 bar and a temperature of 70° C., was simulated with a mathematical model having a Cartesian geometry. The extension of the reservoir was considered equal to 500 m in both direction x and in direction y. The numerical model consisted of 50 cells in direction x, 50 cells in direction y and 15 cells in the vertical direction, for a total thickness of the reservoir equal to 15 m.

The water flooding was simulated considering a 5-spot scheme (an injection well at the centre and 4 production wells at the vertexes of the model).

The simulation of the injection of the aqueous dispersion comprising the microcapsules started at the moment in which the fraction of water produced with respect to the total liquid production in the oil field was equal to 0.85.

The following petrophysical characteristics of the reservoir were assumed for the simulation:
porosity of the reservoir equal to 20%,
rock compressibility equal to 3·10⁻⁵ bar⁻¹.

The horizontal absolute permeability of the rock formation was varied in the simulations from a minimum value of 30 mD to a maximum value of 1,500 mD.

The end points of the relative permeability curves were assumed as follows:

k_{ro,max} for S_{wi}=0.25

k_{rw,max} for Sₒᵣ=0.30

wherein k_{ro,max} and k_{rw,max} are the maximum relative permeability to oil (at the irreducible water saturation) and, respectively, to water (at the residual oil saturation), and wherein S_{wi} and Sₒᵣ are the irreducible water saturation and, respectively, the residual oil saturation.

The irreducible water saturation was assumed equal to 25% and the residual oil saturation was assumed equal to 30%.

The parameters characterizing the reservoir oil are indicated in Table 1.

TABLE 1

| | Oil |
|---|---|
| Density (API) | 30° |
| Viscosity (cP) | 2 |
| under reservoir | |
| conditions | |

It was also assumed that the reservoir pressure never reached bubble point, so as to have only oil in the reservoir (absence of free gas).

For the aquifer, a water density equal to a 1,000 kg/m³, a formation volumetric factor of 1.03 m³ᵣ/m³_{ST} and a water viscosity value equal to 0.5 cP were assumed.

Scenario 2—Reservoir with High-Permeability Channels

In the second scenario, a system of intersecting high-permeability channels was simulated. The remaining part of the reservoir was considered a low-permeability formation but with a high oil content.

A reservoir located at a depth of 2,000 m, with an initial pressure of 200 bar and a temperature of 70° C., was simulated with a mathematical model having a Cartesian geometry. The extension of the reservoir was considered equal to 500 m in both direction x and in direction y. The numerical model consisted of 50 cells in direction x, 50 cells in direction y and 5 cells in the vertical direction, for a total thickness of the reservoir equal to 6 m.

An injection well and a production well, both horizontal, were located in opposite points of the model. The model simulates the flow of the injected water, which essentially flows along the channels, without causing the displacement of the oil from the low-permeability zones.

In the simulation, the injection of the aqueous dispersion comprising the microcapsules started at the moment in which the fraction of water produced with respect to the total liquid production in the oil field was 0.90.

The following petrophysical characteristics of the reservoir were assumed for the simulation:
porosity of the reservoir equal to 20%,
rock compressibility equal to 3·10⁻⁵ bar⁻¹.

The horizontal absolute permeability of the rock formation was varied in the simulations, assuming the following horizontal absolute permeability values from 40 mD to 50,000 mD.

The end points of the relative permeability curves were assumed as follows:

k_{ro,max} for S_{wi}=1

k_{rw,max} for Sₒᵣ=1

wherein k_{ro,max}, k_{rw,max}, S_{wi} and Sₒᵣ have the meaning indicated above.

The critical water saturation was assumed equal to 25% and the residual oil saturation was assumed equal to 30%.

The parameters characterizing the reservoir oil are indicated in Table 2.

TABLE 2

| | Oil |
|---|---|
| Density (API) | 30° |
| Viscosity (cP) | 5 |
| under reservoir | |
| conditions | |

It was also assumed that the reservoir pressure never reached bubble point, so as to have only oil in the reservoir (absence of free gas).

For the aquifer, a water density equal to a 1,000 kg/m³, a formation volumetric factor of 1.03 m³ᵣ/m³_{ST} and a water viscosity value equal to 0.5 cP were assumed.

Simulation and Results

For the simulation of the micro(nano)structured fluid, the TRACERS option of the Black Oil ECLIPSE software was used, which allows the injection of a polymeric barrier substance to be simulated as the concentration of a tracer compound dispersed in water. The TRACERS option also allows a delay in the activation of the polymer to be assigned (clogging of the intergranular porous spaces) with respect to the moment of injection.

The density of the micro(nano)structured fluid which is injected into the reservoir was assumed in both scenarios equal to 1,000 kg/m³, whereas its viscosity was assumed equal to 0.5 cP.

The activation of the microcapsules coincides with the release of the permeability modifying substance and therefore with the beginning of the reduction effects of the permeability in the reservoir. In the simulation, the activation was programmed for the 90^{th} day after injection in scenario 1 and on the 30^{th} day after injection in scenario 2. The injection of the polymer was followed by a water injection period in both scenarios.

In order to simulate the effects of the barrier compound (polymer), it was assumed that its presence influences the absolute permeability of the reservoir. The degree of absolute permeability reduction was correlated with the concentration of the barrier substance, by establishing a limit concentration of the barrier substance.

The progressive reduction in the permeability following the release in situ of the barrier substance contained in the microcapsules was simulated by updating the reservoir parameter values in each cell with a variation in the concentration of the barrier substance calculated by the software. The update of the reservoir parameter values was obtained by means of an automatic processing of the output data of the ECLIPSE software, using a second processing program, developed on purpose. This second program verifies when the concentration value calculated in each cell exceeds the assigned limit value; when this condition is verified, the second program calculates a new absolute permeability value for the cell by multiplying the permeability value by a reduction factor which depends on the given relation between the limit and the actual concentrations of the polymer.

The calculation of the simulation program was continued until simulating a continuative production from the extraction well having a duration of 7 years for scenario 1 and 4 years for scenario 2.

By using the calculation model described above, it was possible to evaluate the effectiveness of the reduction of water permeability in the high-permeability layers or channels in terms of increase in the recovery factor and reduction in water production with respect to the reference scenario (without the injection of micro(nano)structured fluid).

The results of the simulation by means of the mathematical model show that the permeability reduction in layers or channels by injection and subsequent formation in situ of barrier substances allows an increase in the recovery factor (RF) in all the hypothetical scenarios. The efficacy of the present invention can be observed in FIGS. 1-4.

In FIG. 1, the curves 1a and 1b refer to the simulations of the flow-rates (Qo) of oil production (in m³_{ST}/day) versus time t (days) without (1a—continuous line) and with (1b—dashed line) the injection of barrier substances. The curves 1c and 1d refer to the value of the water fraction (Tₘ), with respect to the total liquid production in the oil field, versus time, without (1c—continuous line) and with (1d—dashed line) the injection of barrier substances.

FIG. 2 shows the results of the simulation of the cumulative oil production curves (Np, in m³_{ST}) versus time t (days) without (curve 2a—continuous line) and with (curve 2b—dashed line) the injection of barrier substances.

FIGS. 1 and 2 refer to the case of the simulation according to scenario 1.

In FIG. 3, the curves 3a and 3b refer to the simulations of the flow-rates (Qo) of oil production (in m³_{ST}/day) versus time t (days) without (3a—continuous line) and with (3b—dashed line) the injection of barrier substances. The curves 3c and 3d refer to the value of the water fraction (Tₘ), with respect to the total liquid production in the oil field, versus time, without (3c—continuous line) and with (3d—dashed line) the injection of barrier substances.

FIG. 4 shows the results of the simulation of the cumulative oil production curves (Np, in m³_{ST}) versus time t (days) without (curve 4a—continuous line) and with (curve 4b—dashed line) the injection of barrier substances.

FIGS. 3 and 4 refer to the case of the simulation according to scenario 2.

The results of the simulations indicate that with the method of the present invention, it is possible to obtain an increase in the recovery factor equal to about 36% after 7 years of water flooding in scenario 1 and equal to about 80% after 4 years of water flooding in scenario 2 with respect to the respective reference scenarios, in which the water flooding is applied without being preceded by any injection of permeability modifying compounds.

1. A method for recovering oil from a reservoir, the method comprising:
a) injecting a volume of a micro(nano)structured fluid with controlled release of barrier substances into at least one portion of an underground reservoir containing oil, said micro(nano)structured fluid comprising an aqueous dispersion of microcapsules comprising
a core comprising a modifying substance having the absolute permeability of a rock formation which contains said reservoir, and
a protective shell insoluble in water which coats said core;
b) clogging intergranular porous spaces of said rock formation with said modifying substance with a reduction or inhibition of the absolute permeability of said rock formation,
c) recovering said oil from a remaining portion of said reservoir by the further injecting a displacing fluid.

2. The method according to claim 1, wherein contents of said core are released in a controlled form by dissolution of said protective shell by contact with said oil present in the reservoir.

3. The method according to claim 1, wherein contents of said core are released in a controlled way by thermal decomposition of said protective shell.

4. The method according to claim 1, wherein contents of said core are released in a controlled way by diffusion through said protective shell.

5. The method according to claim 1, wherein said portion of reservoir into which said micro(nano)structured fluid is injected is a portion of reservoir in which the oil originally contained has been displaced and produced by injection of water.

6. The method according to claim 1, further comprising, after the injecting a) and before the recovering c), injecting a volume of water, into the same portion of said reservoir, to drive said volume of micro(nano)structured fluid towards a preselected point of said reservoir.

7. The method according to claim 6, wherein said injections of the micro(nano)structured fluid and the water are repeated, once or several times, before the recovering c).

8. The method according to claim 1, wherein said aqueous dispersion comprises microcapsules having a core comprising one or more monomers and/or pre-polymers (monomer-microcapsules) and microcapsules having a core comprising a cross-linking agent (crosslinking-microcapsules).

9. The method according to claim 8, wherein said micro(nano)structured fluid is an aqueous dispersion comprising said monomer-microcapsules and said crosslinking-microcapsules.

10. A microcapsule, comprising:
a core comprising a modifying substance having the absolute permeability of a rock formation of an oil reservoir; and
a protective shell insoluble in water which coats said core.

11. The microcapsule according to claim 10, wherein said modifying substance is a metal-alkoxide, wherein the metal is selected from Si, Al, Ti and Zr.

12. The microcapsule according to claim 11, wherein said modifying substance is an alkoxy-silane selected from the group consisting of tetramethylorthosilane (TMOS), tetraethylorthosilane (TEOS), trimethylmethoxysilane (TMMS), methyltrimethoxysilane (MTMS) and methyltriethoxysilane (MTES).

13. The microcapsule according to claim 10, wherein said core comprises one or more monomers or pre-polymers or it comprises a cross-linking agent.

14. The microcapsule according to claim 13, wherein said core comprises said monomers and/or pre-polymers which are selected from the group consisting of acrylamide, N,N′-methylene-bis-acrylamide, and partially hydrolyzed polyacrylamide.

15. The microcapsule according to claim 13, wherein said cross-linking agent is selected from the group consisting of composites of Cr or Al, glutaraldehyde, formaldehyde, phenol, o-aminobenzoic acid, m-aminophenol, phenylacetate and furfuryl alcohol.

16. The microcapsule according to claim 10, wherein said core comprises a polymer selected from the group consisting of polyethyleneglycol, polyacrylate, polymethacrylate, polystyrene, cellulose, and polylactate, poly(lactic-co-glycol) copolymer.

17. The microcapsule according to claim 10, wherein:
said core comprises starch; and
said coating shell is made of polyacrylate.

18. The microcapsule according to claim 10, wherein:
said core comprises tetramethylorthosilane; and
said coating shell consists of an acrylic polymer comprising in polymerized form a mono- or multi-functional acrylic resin.

19. A micro(nano)-structured fluid, comprising an aqueous dispersion of microcapsules according to claim 10.

20. (canceled)
